(19) United States
(12) Patent Application Publication
(10) Pub. No.: US 2009/0155515 A1
(43) Pub. Date: Jun. 18, 2009

(54) OPTICAL RECORDING FILM FOR OPTICAL RECORDING MEDIUM AND OPTICAL RECORDING MEDIUM

(75) Inventors: Hironori KAKIUCHI, Kobe-shi (JP); Hideo FUJII, Kobe-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Kobe Seiko Sho (Kobe Steel Ltd), Kobe-shi (JP)

(21) Appl. No.: 12/271,234

(22) Filed: Nov. 14, 2008

(30) Foreign Application Priority Data
Dec. 17, 2007 (JP) 2007-325128

(51) Int. Cl. B32B 15/00

(52) U.S. Cl. 428/64.4

(57) ABSTRACT

Disclosed herein is a recording film for an optical recording medium, in which recording marks are to be formed by irradiation with a laser beam. The recording film is made of an In-base alloy containing either of an In—Ni alloy and an In—Co alloy or both the In—Ni alloy and In—Co alloy in a content in the range of 1 to 50% at. and nitrogen. The In—Ni alloy preferably has a nitrogen content in the range of 5 to 14% at. and the In—Co alloy preferably has a nitrogen content in the range of 5 to 20% at.

### BACKGROUND OF THE INVENTION

1. Field of the Invention

The present invention relates to an optical recording film for an optical recording medium, and an optical recording medium. An optical recording film of the present invention is suitable for use on compact disks (CDs), digital versatile disks (DVDs), and optical recording mediums of the next generation, such as HD-DVDs and blu-ray disks. More particularly, the present invention relates to an optical recording film suitable for a write-once read-many optical recording medium capable of high-density recording to which data is written with a violet laser beam.

2. Description of the Related Art

Optical recording mediums, namely, optical disks, are classified roughly by read-write system into read-only optical recording mediums, rewritable optical recording mediums and write-once read-many optical recording mediums.

The write-once read-many optical disk records data by using the change of the physical property of a recording film that occurs when the recording film is irradiated with a laser beam. The write-once read-many optical disk permits writing information thereto and inhibits erasing recorded information and rewriting. The write-once read-many optical disk having such a characteristic is used for preserving document and image files having data that will not be corrected or changed. CD-R, DVD-R and DVD+R are write-once read-many optical disks on the market.

Organic coloring matters including cyanine and phthalocyanine are generally known materials for forming recording films for write-once read-many optical disks. When irradiated with a laser beam, a recording film of an organic coloring matter absorbs heat, whereby the organic coloring matter and the substrate are decomposed, melted and evaporated to form recording marks. To form a recording film of an organic coloring matter on a substrate, the organic coloring matter needs to be dissolved in an organic solvent to prepare an organic coloring matter solution, and then the organic coloring matter solution needs to be applied to the substrate. Thus such recording film cannot be formed at a high productivity. Since the organic coloring matter are comparatively sensitive to light, the recording film of the organic coloring matter is unsatisfactory in light stability and has problems in storing recorded signal for a long time.

A pitting recording method previously proposed to solve those problems in the organic coloring matter uses an organic thin film as an optical recording film and irradiates the organic thin film with a laser beam to form recording marks, such as holes or pits, in the organic film for recording.

The pitting recording method forming a recording film using one or two organic thin films is advantageous in cost and productivity. However, the pitting recording method needs to heat parts of the organic thin film at a temperature higher than the melting point of the organic film to form holes or pits and necessarily requires a high-power laser. When a laser beam emitted by a high-power laser is used, drops of molten organic thin film melted by the heat of the laser beam are liable to remain in pots formed by forming holes or pits in the organic thin film. Such drops of the molten organic thin film remaining in the pots obstruct the change of the recording marks in reflectivity and, consequently, signals cannot be modulated at a high modulation factor.

Various optical recording films are disclosed to solve the foregoing problems. Each of recording films disclosed in JP-A 2004-5922 and JP-A2004-234717 is formed by superposing a reactive film of a Cu-base alloy containing Al and a reactive film containing Si. A recording film disclosed in JP-A 2002-172861 is made of a Cu-base alloy containing In. A recording film disclosed in JP-A 2002-144730 is made of an Ag-base alloy containing Bi and such. A recording film disclosed in JP-AH 2-117887 is made of a Sn—Cu alloy containing Bi and In and has a thickness in the range of about 1 to about 8 nm. A recording film disclosed in JP-A 2001-180114 is made of a Sn—Bi alloy containing a substance more susceptible to oxidation than Sn and Bi. A Sn-base alloy disclosed in JP-A 2002-225433 contains Bi and such. A recording film disclosed in JP-A 2006-182030 is made of a mixture of a low-temperature decomposable Cu or Ag nitride, and a high-temperature decomposable compound containing Ge, Ti, Si and Al.

Research and development activities have been actively made in recent years to develop techniques relating to optical recording mediums to which signals are written by using a short-wave laser, such as a laser that emits a violet laser beam. The recording film of the optical recording medium is required to be capable of maintaining high reflectivity and excellent in recording sensitivity even if a laser having a low power in the range of about 6 to about 7 mW is used for writing data and in durability.

C/N ratio (carrier-to-noise ratio, namely, the ratio of the output level of carrier to that of noise), and jitter are indices of recording sensitivity. C/N ratio is required to be high and jitter is required to be low. A high C/N ratio signifies that the intensity of read signals is high and ground noise is low. A low jitter signifies that irregularities in the position of reproduced signals are small. Signal modulation factor may be used as an index instead of jitter. A high signal modulation factor signifies low jitter indirectly.

### SUMMARY OF THE INVENTION

The present invention has been made in view of the foregoing problems and it is therefore an object of the present invention to provide a recording film for an optical recording medium, capable of recording signals at a high signal modulation factor and a high C/N ratio by using a laser beam emitted by a laser having a low output capacity in the range of about 6 to about 7 mW and excellent in durability, and to provide an optical recording medium provided with the same recording film.

A primary aspect of the present invention resides in a recording film for an optical recording medium, in which recording marks are to be formed by irradiation with a laser beam. The recording film comprises an In-base alloy containing either of an In—Ni alloy and an In—Co alloy or both the In—Ni alloy and In—Co alloy in a content in the range of 1 to 50% at. and nitrogen.

Preferably, the In—Ni alloy has a N content in the range of 5 to 14%.

Preferably, the In—Co alloy has a N content in the range of 5 to 20%.

Preferably, the laser beam has a wavelength in the range of 350 to 700 nm.

Preferably, the laser beam has a wavelength in the range of 380 to 450 nm.

An optical recording medium according to the present invention is provided with any one of the foregoing recording films according to the present invention.

The present invention provides the recording film for an optical recording medium, capable of recording signals at a high signal modulation factor and a high C/N ratio by using a laser beam emitted by a laser having a low output capacity in the range of about 6 to about 7 mW and excellent in durability, and the optical recording medium provided with the same recording film.

### BRIEF DESCRIPTION OF THE DRAWINGS

The above and other objects, features and advantages of the present invention will become apparent from the following description taken in connection with the accompanying drawings, in which:

FIG. 1 is a typical sectional view of an optical recording medium in a preferred embodiment according to the present invention;

FIG. 2 is a graph showing the dependence of variation of signal modulation factor with the power of a recording laser on the N content of an In—Ni alloy for Examples 1 to 4 of the first embodiment;

FIG. 3 is a graph showing the dependence of variation of C/N ratio with the power of a recording laser on the N content of an In—Ni alloy for Examples 1 to 4 of the first embodiment;

FIG. 4 is a graph showing the dependence of variation of signal modulation factor with the power of a recording laser on the N content of an In—Co alloy for Examples 5 to 8 of the first embodiment;

FIG. 5 is a graph showing the dependence of variation of C/N ratio with the power of a recording laser on the N content of an In—Co alloy for Examples 5 to 8 of the first embodiment; and

FIG. 6 is a graph showing the dependence of variation of reflectivity change with time on the N content of an In—Co alloy for Examples 5 to 8 of the first embodiment determined through a constant-temperature constant-humidity test.

### DESCRIPTION OF THE PREFERRED EMBODIMENTS

The inventors of the present invention made studies of In-base alloys to provide a pit-formation type recording film having high recording sensitivity, excellent in durability and suitable for use in a write-once read-many optical recording medium of the next generation to which signals are written with a blue laser beam and found that such a desirable recording can be made of an In-base alloy containing either of an In—Ni alloy containing Ni in a predetermined content and an In—Co alloy containing Co in a predetermined content or both the In—Ni alloy and In—Co alloy in a predetermined content and nitrogen in a predetermined content.

In this specification, an expression, “excellent in recording sensitivity” signifies a condition where the signal modulation factor is as high as 50% or above and the C/N ratio is as high as 45 dB or above when a recording laser having an output capacity in the range of about 6 to about 7 mW is used. In the following description, signal modulation factors not lower than 50% will be referred to as “high signal modulation factor, and a C/N ratio not lower than 45 dB will be referred to as “high C/N ratio” in some cases.

In this specification, an expression, “excellent in durability” signifies a condition where the absolute value of a reflectivity change ΔR between the reflectivity of a recording film of an optical recording medium measured before subjecting the recording film to a constant-temperature constant-humidity test that holds an optical recording medium provided with the recording film at 80° C. and 85% RH for 96 hr and that of the same after the constant-temperature constant-humidity test is 15% or below. The durability of the recording film when the recording film is held in a constant-temperature constant-humidity environment can be evaluated on the basis of reflectivity change ΔR.

Details of the achievement of the present invention and the constitution of the present invention will be described.

The present invention uses In as a base metal because In has a low melting point and does not impart serious influence to the environment, i.e., has weak toxicity. From only the viewpoint of securing satisfactory reflectivity, Al, Ag and Cu are more desirable than In as a base metal. However, In is far more excellent than Al, Ag and Cu in forming recording marks when irradiated with a laser beam. It is inferred that a thin film of an In-base alloy melts or deforms easily at a low temperature when irradiated with a laser beam emitted by a low-capacity laser and can exhibit excellent recording performance because the melting point of about 156.6° C. of In is far lower than the respective melting points of about 660° C., about 962° C. and about 1085° C. of Al, Ag and Cu. A principal object of the present invention is to provide a recording film for an optical disk of the next generation to which signals are written by using a violet laser beam. There is the possibility that it is difficult to form recording marks in a recording film of an Al-base alloy with a violet laser beam and hence the present invention uses an In-base alloy. It is known that articles of In are excellent in durability. Accordingly, the present invention uses an In-base alloy.

The present invention uses an In-base alloy containing Ni or Co, such as an In—Ni alloy or an In—Co alloy. A drawback of an In film, such as incapability of achieving high C/N ratio, can be improved by adding Ni and/or Co to the In film, that is by using a film of an In-base alloy containing Ni or Co. Since the melting point of In is low, a recording film of pure In cannot ensure reproducing signals at a high C/N ratio and has a rough surface unsatisfactory in smoothness. Such a recording film of pure In is practically inferior. Use of an In-base alloy containing Ni and/or Co for forming a recording film gives the recording film the desirable intrinsic property of In, and eliminates the drawback of the recording film of In, such as incapability of achieving high C/N ratio and unsatisfactory surface smoothness. The applicant of the present invention patent application previously made patent application, Jpn. Pat. App. No. 2006-215745 on the basis of the foregoing new knowledge.

The applicant of the present invention patent application made further studies of the recording sensitivity and durability of recording films of and In—Ni alloy and those of an In—Co alloy after the foregoing patent application. It was found through the studies that the recording film of an In—Ni alloy is satisfactory in durability and inferior in recording sensitivity, and requires a high-power laser for recording signals thereon at a high signal modulation factor of 50% or above and for reproducing signals therefrom at a high C/N ratio of 45 dB or above and that the recording film of an In—Co alloy is satisfactory in recording sensitivity, and is unsatisfactory in reliability in preserving signals, i.e., unsatisfactory in durability, because the reflectivity thereof was changed greatly by the constant-temperature constant-humidity test.

It was found through further studies made to solve the foregoing problems in an In—Ni alloy and an In—Co alloy that the foregoing problems can be solved and recording films having satisfactory recording sensitivity and reliability in data preservation can be formed by those alloys when nitrogen is added in a predetermined content to those alloys. The present invention has been made on the basis of such a finding.

Although details of the effect of addition of nitrogen to an In—Ni alloy and an In—Co alloy on solving the foregoing problems are not clearly known, it is presumed that addition of nitrogen to an In—Ni alloy reduces the thermal conductivity of the In—Ni alloy, and recording sensitivity is improved by enhancing the efficiency of energy utilization, and that addition of nitrogen to an In—Co alloy suppresses the oxidation of the recording film and reliability in data preservation, namely, durability, of the recording film is improved.

An In—Ni alloy and an In—Co alloy employed in the present invention will be described.

In—Ni Alloy

Nickel (Ni) increases surface tension to improve wettability and contributes to the improvement of durability. Such effects of Ni is effective when the Ni content of the In—Ni alloy is 1% or above. However, an excessively high Ni content of the In—Ni alloy increases the melting point of the In—Ni alloy, which reduces the recording sensitivity of a recording film of the In—Ni alloy. To improve both recording sensitivity and durability, a preferable Ni content of the In—Ni alloy is in the range of 10% to 45%, more desirably, in the range of 20% to 40%.

The In—Ni alloy has a nitrogen content in the range of 5% to 14%. Although the In—Ni alloy not containing nitrogen is satisfactory in durability, the In—Ni alloy needs to have a nitrogen content in the foregoing range to ensure recording sensitivity of a level required by the present invention. More specifically, a desired high signal modulation factor cannot be achieved by a low recording power if the nitrogen content of the In—Ni alloy is below 5%, and a desired high C/N ratio cannot be achieved by low recording power if the nitrogen content of the In—Ni alloy is above 14%. Accordingly, it is preferable that the nitrogen content of the In—Ni alloy is in the range of 5% to 14%, more desirably, in the range of 8% to 13% to enhance both recording sensitivity and durability.

The respective nitrogen contents of the In—Ni alloy and the In—Co alloy can be measured by XPS (x-ray photoelectron spectroscopy). The highest one of nitrogen contents of parts at different depths from the surface of an optical recording film of the present invention is used as the nitrogen content of an optical recording film of the present invention.

In—Co Alloy

Cobalt (Co) increases surface tension to improve wettability. Such an effect of Co is effective when the Co content of the In—Co alloy is 1% or above. However, an excessively high Co content of the In—Co alloy increases the melting point of the In—Co alloy, which reduces the recording sensitivity of a recording film of the In—Co alloy. The upper limit of the Co content is 50%. To improve both recording sensitivity and durability, the lower limit of the Co content is 10%, more desirably, 25%. A preferable upper limit of the Co content is 45%.

The In—Co alloy has a nitrogen content in the range of 5% to 20%. Although the In—Co alloy not containing nitrogen or containing nitrogen in a high nitrogen content is satisfactory in signal modulation factor, the In—Co alloy needs to have a nitrogen content in the foregoing range to ensure both high C/N ratio and high durability. More specifically, durability is unsatisfactory if the nitrogen content of the In—Co alloy is below 5%, and a desired high C/N ratio cannot be achieved by a low recording power if the nitrogen content of the In—Co alloy is above 20%. Accordingly, it is preferable that the nitrogen content of the In—Co alloy is in the range of 5% to 20%, more desirably, in the range of 10% to 19% to enhance both recording sensitivity and durability.

Although the In—Ni alloy and the In—Co alloy have been described by way of example, the present invention includes also an In-base alloy containing both Ni and Co, namely, an In—Ni—Co alloy, preferably having the sum of a Ni content and a Co content in the range of 1% and 50%.

The In-base alloys for forming optical recording films of the present invention were described.

Although dependent on the construction of an optical recording medium, it is preferable that the thickness of an optical recording film is in the range of about 1 to about 50 nm. An optical recording film having a thickness below 1 nm is excessively thin. Defects, such as pores, are liable to be formed in such an excessively thin optical recording film even if, for example, an optical control layer or a dielectric layer overlies or underlies the optical recording film and, in some cases, the optical recording film cannot achieve a desired recording sensitivity. An optical recording film having a thickness above 50 nm is excessively high. Heat generated by a laser beam in such an excessively thick optical recording film is liable to be dissipated rapidly and it is difficult to form recording marks in the excessively thick optical recording film. When neither of an optical control layer and a dielectric layer is formed, it is preferable that the thickness of the optical recording film is in the range of 8 to 50 nm, more desirably, in the range of 10 to 25 nm. When either of an optical control layer and a dielectric layer is formed, it is preferable that the thickness of the optical recording film is in the range of 3 to 30 nm, more desirably, 5 to 25 nm.

Preferably, the wavelength of a laser beam used for recording is in the range of 350 to 700 nm. A laser beam having a wavelength below 350 nm is absorbed considerably by a cover layer, namely, an optically transparent layer, and has difficulty in writing signal to and reading signal from the optical recording film. A laser beam having an excessively long wavelength above 700 nm has insufficient energy and has difficulty in forming recording marks in the optical recording film. Preferably, the wavelength of the laser beam is in the range of 350 to 660 nm, more desirably, in the range of 380 to 650 nm.

The In-base alloy thin film of the present invention can be formed by, for example, a sputtering process or vapor deposition process. A sputtering process is desirable. Each of alloying elements, such as Ni and Co, other than In has an intrinsic solubility limit at which the alloying element can dissolve in an In solid solution of in a thermal equilibrium state. When a thin film is formed by a sputtering process, the alloying element disperses uniformly in an In matrix. Consequently, a thin film having a uniform quality, stable optical characteristics and resistance to environmental influence can be easily formed.

Preferably, the thin film of the In-base alloy is deposited by a reactive sputtering process using a mixed gas containing N₂ and an inert gas, such as Ar or Ne. More concretely, the nitrogen content of the thin film of the In-base alloy can be adjusted to a nitrogen content in a range specified by the present invention by properly changing the F2/F1 ratio, where F1 is the flow rate of the inert gas and F2 is the flow rate of N₂. Preferably, the respective flow rates of Ar and N₂ are controlled such that the Ar/N₂ flow rate ratio is in the range of about 2/1 to about 10/1, desirably, about 4/1 to deposit a thin film of an In—Ni alloy. Preferably, the respective flow rates of Ar and N₂ are controlled such that the Ar/N₂ flow rate ratio is in the range of about 3/1 to about 8/1, desirably, about 4/1 to deposit a thin film of an In—Co alloy.

Although there are not particular restrictions of other deposition conditions, the followings are examples of desirable conditions.

Temperature of substrate: Room temperature to 50° C.

Process vacuum: 3.0×10⁻⁶ Torr or below

Gas pressure for deposition: 1 to 3 mTorr

DC sputtering power density: 0.6 to 1.2 W/cm

DC sputtering power density is the amount of dc sputtering power per unit area of 1 cm² in a target.

A sputtering target for the sputtering process can be made by a vacuum casting process, a sintering process or a spray forming process. It is particularly desirable to use an In-base alloy target made by a vacuum casting process (hereinafter referred to as “cast In-base alloy target”). The cast In-base alloy target is uniform in structure and composition and is sputtered at a stable sputtering yield and atoms are ejected uniformly in all directions from the cast In-base alloy target. Therefore, an optical recording film having uniform composition can be easily deposited by using the cast In-base alloy target and a high-performance optical disk can be manufactured by using the optical recording film thus formed.

Basically, the composition of the sputtering target for forming the optical recording film is the same as the composition of the In—Ni alloy or the In—Co alloy for forming the optical recording film. The composition of the optical recording film formed by a sputtering process using such a sputtering target is the same as the sputtering target.

An optical recording medium is provided with the In-base alloy recording film. The construction of the optical recording medium excluding the recording film may be the same as the construction generally known in the field of optical recording mediums.

FIG. 1 is a typical sectional view of a write-once read-many optical disk 10, namely, an optical recording medium, in a preferred embodiment according to the present invention. Data can be written to and can be read from the write-once read-many optical disk 10 by using a violet laser beam having a wavelength in the range of about 380 to about 450 nm, desirably, 405 nm. The optical disk includes a substrate 1, a recording layer 2, and an optically transparent layer 3, namely, a cover layer 3.

For example, an optical control layer or a dielectric layer may be interposed between the substrate 1 and the recording layer 2, and a dielectric layer may be interposed between the recording layer 2 and the optically transparent layer 3. An optical control layer and a dielectric layer can enhance the reflectivity of the optical disk.

The optical disk shown in FIG. 1 is a single-layer optical disk provided with the single recording layer 2 and the single optically transparent layer 3. The dual-layer optical disk may be provided with at least two layers each of the recording layer 2 and the optically transparent layer 3.

As mentioned above, the present invention is characterized by the In-base alloy used for forming the recording film of the optical recording medium. Therefore, there are not particular restrictions on the materials of the substrate 1, the optically transparent layer 3, the optical control layer and the dielectric layer. The substrate 1 and those layers excluding the recording layer 2 may be formed of materials chosen from those generally used in the field of optical recording mediums.

For example, suitable materials for forming the Substrate 1 are polycarbonate resins, norbornane resins, cyclic olefin polymers and amorphous polyolefins.

For example, suitable materials for forming the optical control layer are Ag, Au, Cu, Al, Ni, Cr, Ti and alloys of some of those metals. Suitable materials for forming the dielectric layer are Zn—S—SiO₂, oxides of Si, Al, Ti, Ta, Zr and Cr, nitrides of Ge, Cr, Si, Al, Nb, Mo, Ti and Zn, carbides of Ge, Cr, Si, Al, Ti, Zr and Ta, fluorides of Si, Al, Mg, Ca and La, and mixtures of those materials.

### EXAMPLES

Examples of the present invention will be described. The following examples are not limitative and changes can be made therein without departing from the scope of the foregoing and the following gist of the present invention, and modifications of the following examples are within the scope of the present invention.

### Example 1

Optical disks provided with 12 μm thick optical recording films respectively of In-base alloys of types A and B were fabricated. The optical disks were tested for modulation factor, C/N ratio and durability.

In-base alloys of type A: In-30% Ni alloys respectively having nitrogen contents shown in Table 1 (In-base alloys Nos. 1 to 4)

In-base alloys of type B: In-27% Co alloys respectively having nitrogen contents shown in Table 1 (In-base alloys Nos. 5 to 8)

(1) Optical Disk Fabricating Method

An optical recording film of the In-base alloys of type A or B was formed by a dc magnetron sputtering process on a surface of a polycarbonate substrate (BD substrate having a thickness of 1.1 mm, a track pitch of 0.32 μm, and grooves having a width of 0.16 μm and a depth of 25 nm).

Sputtering Conditions

Sputtering gas: Mixed gas of Ar and N₂ (Flow rate ratios shown in Table 1 were used)

Process vacuum: 10⁻⁵ Torr or below (1 Torr=133.3 Pa)

Sputtering gas pressure: 1 mTorr

DC sputtering power: 100 W

Sputtering targets: In-30% Ni alloy of type A
In-27% Co alloy of type B

The optical recording films thus formed were coated respectively with films of a UV-curing resin (BRD-130, Nippon Kayaku Co., Ltd.) by a spin coating method. The UV-curing resin films were irradiated with ultraviolet radiation to form optically transparent films having a thickness of 100±15 μm. Thus optical disks were completed.

Respective amounts of the alloying elements contained in the optical recording films, and the respective amounts of nitrogen and oxygen, namely, impurities, contained in the optical recording films were determined by XPS.

The following measuring method, an x-ray source and x-ray power were used. The composition of a surface layer from the surface of a specimen to a depth of several atomic layers can be determined by XPS. Measurement was executed while surface atoms of the specimen were ejected by Ar ion bombardment for removing a surface layer at a removing rate of about 1.3 nm/min (rate in case of SiO₂ film) to determine an XPS spectrum in the direction of depth in the specimen.

Measuring apparatus: Quantera SXM (Physical Electronics)

X-ray source: Monochromatic AlKα

X-ray output power: 25 W

The respective amounts of Ni, Co, N and O were determined from the XPS spectrum by the following method.

Background components were removed from peaks shown below in the XPS spectrum corresponding to the elements by the Shirley method, and the respective peak intensities of the elements were calculated.

In: In3d_{5/2} (Peak: about 444 eV), Ni: Ni2p_{3/2} (Peak: about 853 eV), Co Co2p_{3/2} (Peak about 778 eV), N: N1s (Peak: about 397 eV), and O: O1s (Peak: about 530 eV)

The peak intensities thus determined were converted into element ratios by a relative sensitivity factors method. Respective relative sensitivities of the peaks used by the relative sensitivity factors method were In3d_{5/2}: 6.302, Ni2p_{3/2}: 2.309, Co2p_{3/2}: 2.113, N1s: 0.499 and 01s: 0.733.

(2) Method of Evaluating Optical Disk

The optical disks thus fabricated were examined for modulation factor, C/N ratio and durability in the following manner.

(2-1) Signal Modulation Factor

Tests used an optical disk testing machine (ODU-1000, Pulstec Industrial Co., Ltd.) using a recording laser beam having a wavelength of 405 nm and having a NA (numerical aperture) of 0.85, and a digital oscilloscope (DL1640L, Yokogawa Electric Corporation). Recording marks of 0.60 μm in length corresponding to ST signals stored in a blu-ray disk of 250 GB were formed repeatedly at a linear speed of 4.9 m/s by using a laser beam having power in the range of 4 to 12 mW. The intensity of signals read by using a reading laser beam of 0.3 mW was measured and a signal modulation factor was calculated by using the following expression.

(Signal modulation factor)={(Maximum signal intensity)−(Minimum signal intensity)}/(Maximum signal intensity))×100 (%)

]It was decided that the optical disks were acceptable (indicated by a blank circle) when signals recorded by using a recording laser beam of about 6 to about 7 mW could be read at signal modulation factors of 50% or above from the optical disks. High signal modulation factor signifies low jitter indirectly.

(2-2) Measurement of C/N Ratio

The optical disk testing machine used for the measurement of signal modulation factor, and a spectrum analyzer (R3131A, ADVANTEST CORPORATION) were used. Recording marks were recorded repeatedly by the foregoing method and the recorded marks were read by using a reproducing laser beam of 0.3 mW. The intensity (dB) of a signal component of 4.12 MHz was used as the intensity of a carrier C and the intensity of component signals of frequencies near 4.12 MHz was used as the intensity of noise for calculating the C/N ratio. It was decided that the optical disks from which signals recorded by using a laser beam of about 6 to about 7 mW could be reproduced at C/N ratios of 45 dB or above were acceptable (indicated by blank circles).

(2-3) Durability

The reflectivity of the optical disks was measured before and after a constant-temperature constant-humidity test. Conditions for the constant-temperature constant-humidity test were 80° C., 85% RH and 48 h and 96 h in test time. It was assumed that the initial reflectivity of the optical disk before the constant-temperature constant-humidity test was 100%. A reflectivity change AR caused by the constant-temperature constant-humidity test was measured. A reflectivity change ratio (%), namely, the ratio of the absolute value of AR to the initial reflectivity was calculated. It was decided that the optical disks are acceptable (indicated by blank circle) when the reflectivity change ratios thereof were 15% or below. Reflectivity was measured by a spectrophotometer (V-570, JASCO Corporation)

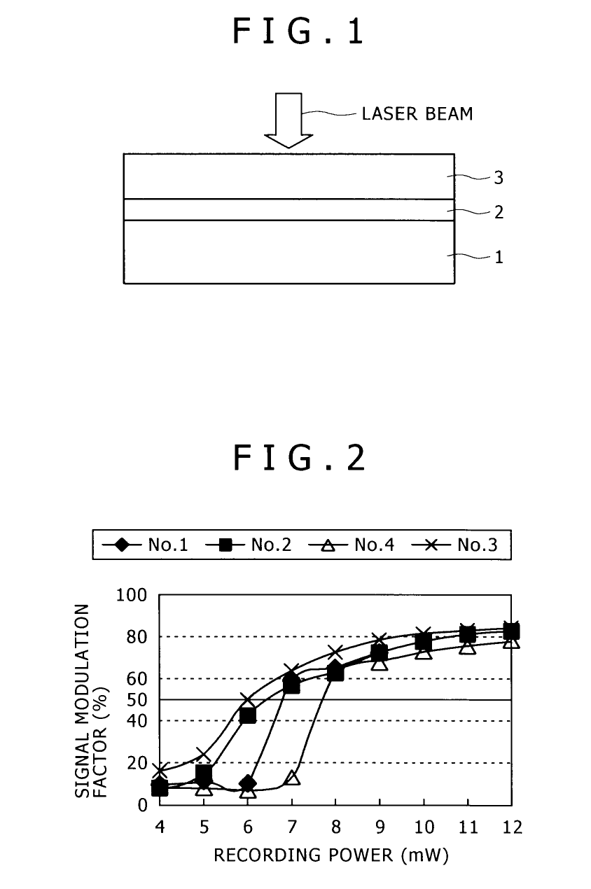

Test results are shown in FIGS. 2 to 6.

Table 1 shows data on the examples of the present invention and results of evaluation of those examples. Acceptable properties are indicated by blank circles and unacceptable properties are indicate by crosses.

TABLE 1

| | | Ar:N₂ | | Properties | | | |
|---|---|---|---|---|---|---|---|
| | | (flow | Nitrogen content | Signal modulation | C/N | | |
| | No. | rate) | (% at.) | factor | ratio | Durability | Comprehensive evaluation |
| In—Ni | 1 | (4:1) | 10.9 | ◯ | ◯ | ◯ | ◯ |
| alloy | 2 | (2:1) | 12.7 | ◯ | ◯ | ◯ | ◯ |
| | 3 | (1:1) | 15.2 | ◯ | X | ◯ | X |
| | 4 | — | 0 | X | X | ◯ | X |
| In—Co | 5 | (8:1) | 12.6 | ◯ | ◯ | ◯ | ◯ |
| alloy | 6 | (4:1) | 19.1 | ◯ | ◯ | ◯ | ◯ |
| | 7 | (2:1) | 20.9 | ◯ | X | ◯ | X |
| | 8 | — | 0.1 | ◯ | ◯ | X | X |

Optical recording disks Nos. 1 to 4 made of the In-30% Ni alloys of type A respectively having different nitrogen contents and shown in Table 1 will be examined.

FIG. 2 is a graph showing the dependence of signal modulation factor on the power of a recording laser beam. In FIG. 2, curves respectively with solid rhombi, solid squares, blank triangles and crosses are for specimens Nos. 1 to 3 of the optical disks provided with optical recording films of the In—Ni alloys respectively having nitrogen contents shown in Table 1, and a curve with blank triangles is for the optical disk provided with an optical recording film of the In—Ni alloy not containing nitrogen. As obvious from FIG. 2, whereas the specimen No. 1 (solid rhombi), the specimen No. 2 (solid squares) and the specimen No. 3 (crosses) provided with the optical recording films of the In—Ni alloy containing nitrogen could achieve high signal modulation factors of 50% or above even if a recording laser beam of low power on the order of about 7 mW was used, the specimen No 4 (blank triangles) provided with the optical recording film made of the In—Ni alloy not containing nitrogen needed a recording laser beam having power on the order of about 8 mW to achieve a signal modulation factor of 50% or above.

The test results showed that the In—Ni alloy needs to contain at least nitrogen to ensure high signal modulation factor.

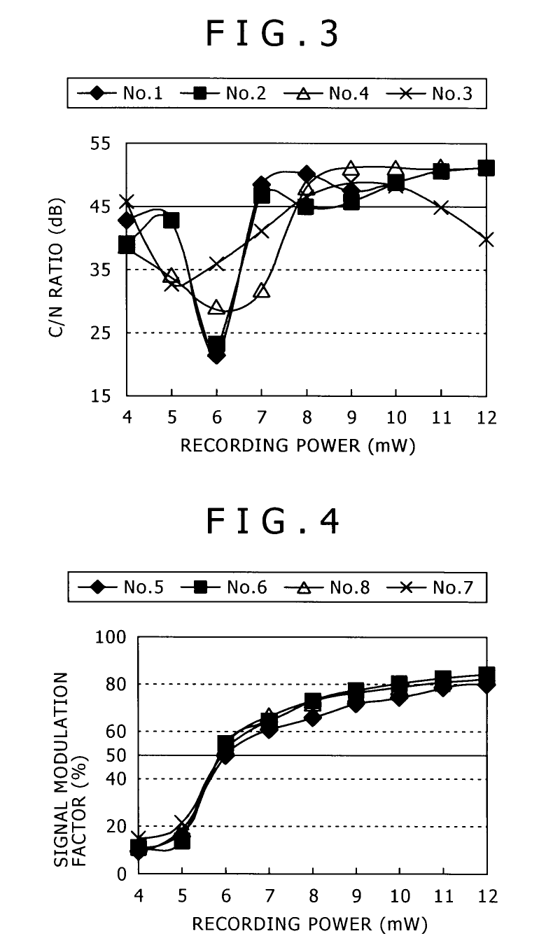

FIG. 3 shows the relation between the C/N ratio of signals and the power of a recording laser beam. As obvious from FIG. 3, whereas the specimen No. 1 (solid rhombi) and the specimen No. 2 (solid squares) provided with optical recording films of the In—Ni alloys respectively having nitrogen contents within a range specified by the present invention could achieve high C/N ratios of 45 dB or above even if a recording laser beam of low power on the order of about 7 mW was used, the specimen No 3 (crosses) provided with an optical recording film made of the In—Ni alloy having a high nitrogen content, and the specimen No. 4 (blank triangles) provided with an optical recording film made of the In—Ni alloy not containing nitrogen needed a recording laser beam having power on the order of about 8 mW to achieve a C/N ratio of 45 dB or above.

Test results showed that it is important that the In—Ni alloy contains nitrogen in a nitrogen content within a range specified by the present invention to achieve a high C/N ratio.

It can be decided that the In—Ni alloys shall have a nitrogen content within the range specified by the present invention, taking the data shown in FIGS. 2 and 3 into consideration.

All the specimens Nos. 1 to 4 had durability meeting an acceptance criterion, which is not shown in Table 1.

Optical recording disks Nos. 5 to 8 made of the In-27% Co alloys of type B respectively having different nitrogen contents and shown in Table 1 will be examined.

FIG. 4 is a graph showing the dependence of signal modulation factor on the power of a recording laser beam. In FIG. 4, curves respectively with solid rhombi, solid squares, blank triangles and crosses are for specimens Nos. 5 to 7 of the optical disks provided with optical recording films of the In—Co alloys respectively having nitrogen contents shown in Table 1, and a curve with blank triangles is for the specimen No. 8 of the optical disk provided with an optical recording film of the In—Co alloy not containing nitrogen. As obvious from FIG. 4, all the specimen No. 5 (solid rhombi), the specimen No. 6 (solid squares) and the specimen No. 7 (crosses) provided with the optical recording films made of the In—Co alloys containing nitrogen, and the specimen No. 8 (blank triangles) provided with the optical recording film of the In—Co alloy not containing nitrogen could achieve high signal modulation factors of 50% or above even if a recording laser beam of low power on the order of about 6 mW was used.

The test results showed that the nitrogen content of the In—Co alloys and whether or not the In—Co alloys contain nitrogen scarcely had effect on the achievement of high signal modulation factor by the optical recording films of the In—Co alloys.

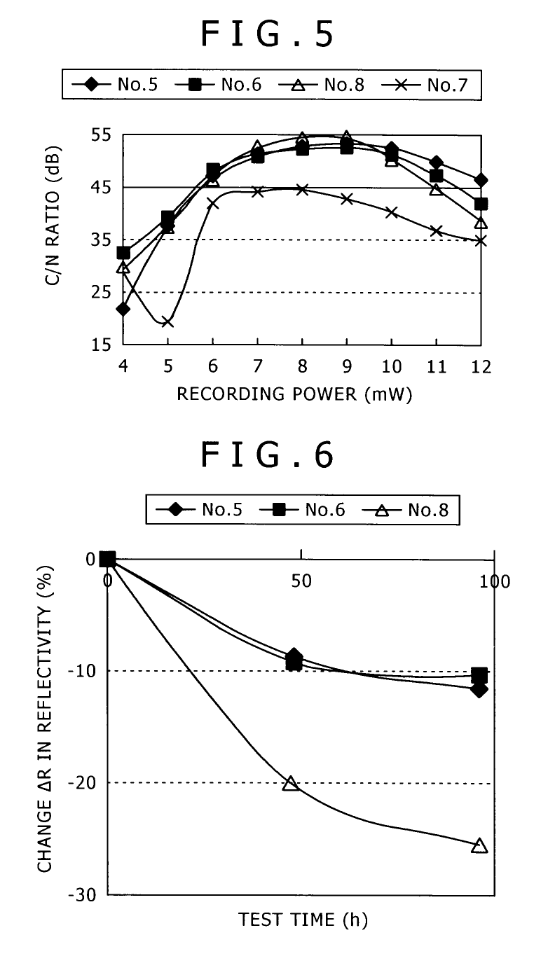

FIG. 5 shows the relation between the C/N ratio of signals and the power of a recording laser beam. As obvious from FIG. 5, whereas the specimen No. 5 (solid rhombi) and the specimen No. 6 (solid squares) provided with optical recording films made of the In—Co alloys having a nitrogen content within a range shown in Table 1, and the specimen No. 8 (blank triangles) provided with an optical recording film of the In—Ni alloy not containing nitrogen can achieve high C/N ratios of 45 dB or above even if a recording laser beam of low power on the order of about 6 mW is used, the specimen No 7 (crosses) provided with an optical recording film made of the In—Co alloy having a high nitrogen content needs a recording laser beam having power on the order of about 8 mW to achieve a C/N ratio of 45 dB or above.8

It is known from the test results that that the In—Co alloy not containing nitrogen or the In—Co alloys having a nitrogen content equal to or below an upper limit nitrogen content specified by the present invention shall be used to achieve a high C/N ratio and that a high signal modulation factor cannot be achieved by a laser beam of low power when the optical recording film is made of an In—Co alloy having an excessively high nitrogen content.

FIG. 6 is a graph showing the variation of reflectivity with time when specimens are subjected to a constant-temperature constant-humidity test. Reflectivity changes AR in the specimens Nos. 5 and 6 provided with the optical recording films of the In—Co alloys respectively having nitrogen contents within the range specified by the present invention are as small as about 11% as indicated by curves respectively with solid rhombi and solid squares shown in FIG. 6, which proves that those specimens Nos. 5 and 6 are satisfactory in durability. On the other hand, a reflectivity change ΔR in the specimen No. 8 provided with the optical recording film of the In—Co alloy not containing nitrogen indicated by a curve with blank triangles in FIG. 6 is as large as about 25%, which proves that the specimen No. 8 is unsatisfactory in durability. The specimen No. 7 provided with the optical recording film of the In—Co alloy having a high nitrogen content, not shown in FIG. 6, was satisfactory in durability.

It is known from the test results that the In—Co alloys shall contain nitrogen in a nitrogen content equal to or above a lower limit nitrogen content specified by the present invention to ensure desired durability.

The present invention defines a nitrogen content range in which the nitrogen content of the In—Co alloys shall be included, generally taking the foregoing test results into consideration.

Although the invention has been described in its preferred form with a certain degree of particularity, obviously many changes and variations are possible therein. It is therefore to be understood that the present invention may be practiced otherwise than as specifically described herein without departing from the scope and spirit thereof.

What is claimed is:

1. A recording film for an optical recording medium, in which recording marks are to be formed by irradiation with a laser beam, said recording film comprising an In-base alloy comprising either of an In—Ni alloy and an In—Co alloy or both the In—Ni alloy and In—Co alloy in a content in the range of 1 to 50% at. and nitrogen.

2. The recording film according to claim 1, wherein the laser beam has a wavelength in the range of 350 to 700 nm.

3. The recording film for an optical recording medium according to claim 2, wherein the laser beam has a wavelength in the range of 380 to 450 nm.

4. An optical recording medium provided with the recording film for an optical recording medium stated in claim 1.

5. The recording film for an optical recording medium according to claim 1, wherein the In—Ni alloy has a nitrogen content in the range of 5 to 14% at.

6. The recording film for an optical recording medium according to claim 5, wherein the laser beam has a wavelength in the range of 350 to 700 nm.

7. The recording film for an optical recording medium according to claim 6, wherein the laser beam has a wavelength in the range of 380 to 450 nm.

8. An optical recording medium provided with the recording film for an optical recording medium stated in claim 5.

9. The recording film for an optical recording medium according to claim 1, wherein the In—Co alloy has a nitrogen content in the range of 5 to 20% at.

10. The recording film for an optical recording medium according to claim 9, wherein the laser beam has a wavelength in the range of 350 to 700 nm.

11. The recording film for an optical recording medium according to claim 10, wherein the laser beam has a wavelength in the range of 380 to 450 nm.

12. An optical recording medium provided with the recording film for an optical recording medium stated in claim 9.
